(19) United States
(12) Patent Application Publication
(10) Pub. No.: US 2018/0003279 A1
(43) Pub. Date: Jan. 4, 2018

(54) TURBINE PISTON

(71) Applicants: David Avins, Burbank, OH (US); Joshua Cerreta, Zuhui District (CN)

(72) Inventors: David Avins, Burbank, OH (US); Joshua Cerreta, Zuhui District (CN)

(73) Assignee: Schaeffler Technologies AG & Co. KG, Herzogenaurach (DE)

(21) Appl. No.: 15/546,043

(22) PCT Filed: Jan. 14, 2016
(86) PCT No.: PCT/US2016/013344

§ 371 Date: Jul. 25, 2017

Related U.S. Application Data
(60) Provisional application No. 62/113,966, filed on Feb. 9, 2015.

(51) Int. Cl. F16H 41/24; F16H 45/02

(52) U.S. Cl. CPC F16H 41/24; F16H 45/02; F16H 2045/0273; F16H 2045/0221

(57) ABSTRACT

A torque converter includes a cover assembly, an impeller assembly, a turbine assembly and a damper assembly. The impeller assembly includes an impeller shell drivingly connected with the cover assembly. The turbine assembly includes a shell with a clutch portion for selective driving engagement with the impeller shell. The damper assembly includes at least one cover plate, a flange for driving engagement with a transmission input shaft, and a first resilient element drivingly engaged with the at least one cover plate and the flange. The torque converter has a second resilient element for urging the turbine assembly away from the cover assembly.

### FIELD

The invention relates generally to a turbine piston, and more specifically to a turbine piston preloaded against an impeller shell.

### BACKGROUND

Turbine pistons are known. One example is shown in commonly-assigned United States Patent Publication No. 2013/0230385.

### BRIEF SUMMARY

Example aspects broadly comprise a torque converter with a cover assembly, an impeller assembly, a turbine assembly and a damper assembly. The impeller assembly includes an impeller shell drivingly connected with the cover assembly. The turbine assembly includes a shell with a clutch portion for selective driving engagement with the impeller shell. The damper assembly includes at least one cover plate, a flange for driving engagement with a transmission input shaft, and a first resilient element drivingly engaged with the at least one cover plate and the flange. The torque converter has a second resilient element for urging the turbine assembly away from the cover assembly.

In some example embodiments, the at least one cover plate is fixed to the turbine shell and the resilient element urges the at least one cover plate away from the cover assembly. In some example embodiments, the cover assembly includes a centering plate and a bushing press-fitted into the centering plate. The flange includes a hub portion installed into the bushing and rotatable relative to the bushing. In some example embodiments, the second resilient element is a diaphragm spring disposed axially between the centering plate and the flange.

In an example embodiment, the bushing includes flanged portion with a first plurality of radial castellations and the diaphragm spring includes a second plurality of radial castellations drivingly engaged with the first plurality of radial castellations for preventing relative rotation between the diaphragm spring and the bushing. In an example embodiment, the torque converter has a hardened washer disposed axially between the diaphragm spring and the flange. In an example embodiment, the torque converter has a hardened washer disposed axially between the diaphragm spring and the bushing. The bushing includes a first annular portion and the flange includes a plurality of cutouts. The hardened washer has a second annular portion matingly engaged with the bushing annular portion and a plurality of tabs installed in the flange cutouts for preventing relative rotation between the hardened washer and the flange.

In some example embodiments, the second resilient element is a diaphragm spring disposed axially between the cover plate and the flange. In an example embodiment, the at least one cover plate includes a radially inwardly extending portion and the diaphragm spring is disposed axially between the inwardly extending portion and the flange. In an example embodiment, the radially inwardly extending portion includes a plurality of first tabs and the diaphragm spring includes a plurality of second tabs engaged with the plurality of first tabs for preventing relative rotation between the diaphragm spring and the cover plate.

In some example embodiments, the second resilient element is disposed axially between the flange and the turbine shell. In an example embodiment, the second resilient element is fixed to the turbine shell. In an example embodiment, the torque converter has a thrust washer disposed axially between the at least one cover plate and the cover assembly.

Other example aspects broadly comprise a torque converter with an outer shell including a cover fixed to an impeller shell and a turbine shell including a clutch portion preloaded against the impeller shell. In an example embodiment, the impeller shell and the turbine shell comprise respective torus portions and the clutch portion is disposed radially outside of the torus portions. In an example embodiment, the torque converter has a stator disposed axially between the impeller shell and the turbine shell. In an example embodiment, the torque converter has a damper assembly disposed in a torque path between the turbine shell and a transmission input shaft. In some example embodiment, the cover shell is arranged for driving engagement with a prime mover. In an example embodiment, the turbine shell clutch portion is preloaded against the impeller shell by a resilient element. In an example embodiment, the resilient element reacts against the cover shell.

### BRIEF DESCRIPTION OF THE DRAWINGS

The nature and mode of operation of the present invention will now be more fully described in the following detailed description taken with the accompanying drawing figures, in which:

FIG. 1 is a top half cross-section view of a torque converter according to an example aspect;

FIG. 2 is a detail view of a torque converter showing an alternative embodiment;

FIG. 3 is a perspective view of a bushing of the torque converter of FIG. 2;

FIG. 4 is a perspective view of a resilient element of the torque converter of FIG. 2;

FIG. 5 is a perspective view of the torque converter of FIG. 2 with the flange removed for clarity;

FIG. 6 is a detail view of a torque converter showing an alternative embodiment;

FIG. 7 is a detail view of a torque converter showing an alternative embodiment;

FIG. 8 is a detail view of a torque converter showing an alternative embodiment;

FIG. 9 is a top half cross sectional view of a torque converter according to an example aspect.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

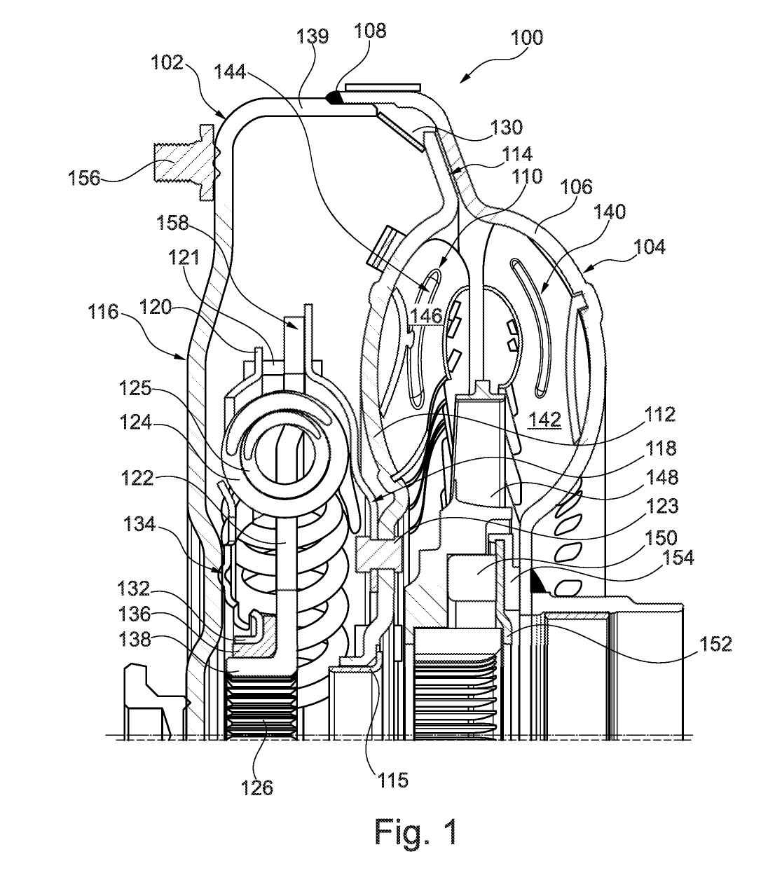

The following description is made with reference to FIG. 1. FIG. 1 is a top half cross-section view of torque converter 100 according to an example aspect. Torque converter 100 includes cover assembly 102, impeller assembly 104 including impeller shell 106 drivingly connected with the cover assembly at weld 108, and turbine assembly 110 including shell 112 with clutch portion 114 for selective driving engagement with the impeller shell. Clutch portion 114 operates in a manner similar to that shown and described in commonly-assigned United States Patent Publication No. 2013/0230385, hereby incorporated by reference as if set forth fully herein. Turbine assembly 110 further includes bushing 115 for sealing engagement with a transmission input shaft (not shown).

Converter 100 also includes damper assembly 116 disposed in a torque path between the turbine shell and a transmission input shaft (not shown). The damper assembly includes cover plates 118 and 120 fixed together at rivet 121, flange 122, and resilient elements (i.e., coil springs) 124 and 125. Flange 122 is for driving engagement with a transmission input shaft (not shown) at spline portion 126, for example. Springs 124 and 125 are drivingly engaged with cover plates 118 and 120, and flange 122. That is, the springs transfer torque between the cover plates and flange. Cover plate 118 is fixed to the turbine shell at rivet 123.

Torque converter 100 further includes resilient element (i.e., diaphragm spring) 130 for urging turbine assembly 110 away from cover assembly 102. In other words, clutch portion 114 is preloaded against impeller shell 106. Cover assembly 102 includes centering plate 132, fixed to the cover assembly at projection weld 134, and bushing 136 press-fitted into the centering plate. That is, the bushing must be forcefully installed into the centering plate such that the two are fixed together. Flange 122 includes hub portion 138 installed into the bushing and rotatable relative to the bushing.

Cover assembly 102 includes outer shell 139. Impeller shell 106 and cover shell 139 form an outer shell for torque converter 100. Element 130 reacts against the cover shell. Impeller shell 106 includes torus portion 140 with blades 142. Turbine shell 112 includes torus portion 144 with blades 146. Clutch portion 114 is disposed radially outside of the torus portions. Stator 148 is disposed axially between the impeller shell and the turbine shell. Stator 148 includes one-way clutch assembly 150, side plate 152, and thrust washer, or hydrodynamic bearing, 154 fixed to the side plate. Cover shell 139 is arranged for driving engagement with a prime mover at stud 156, for example.

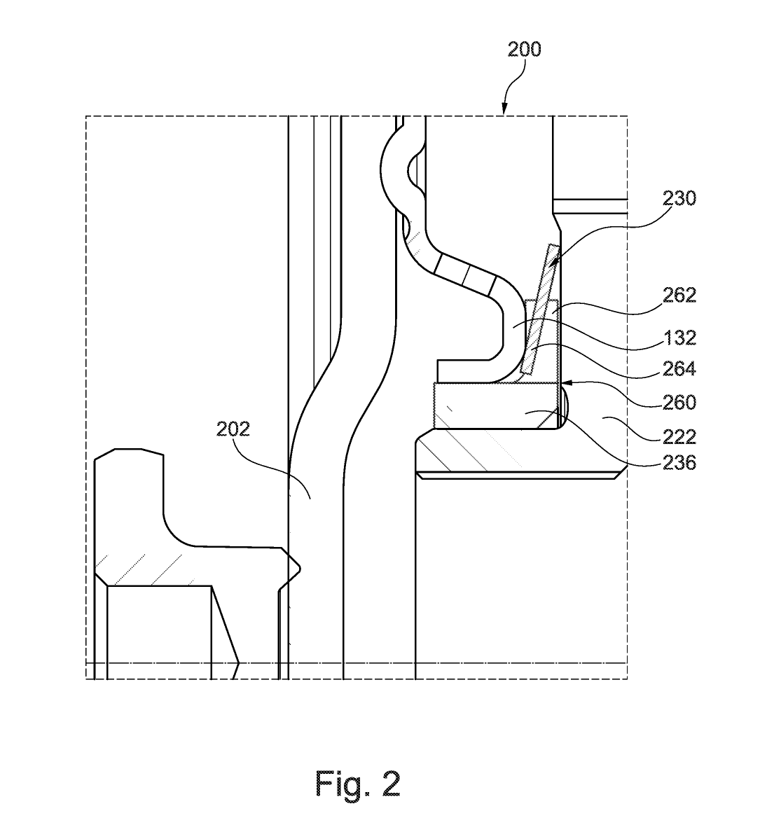

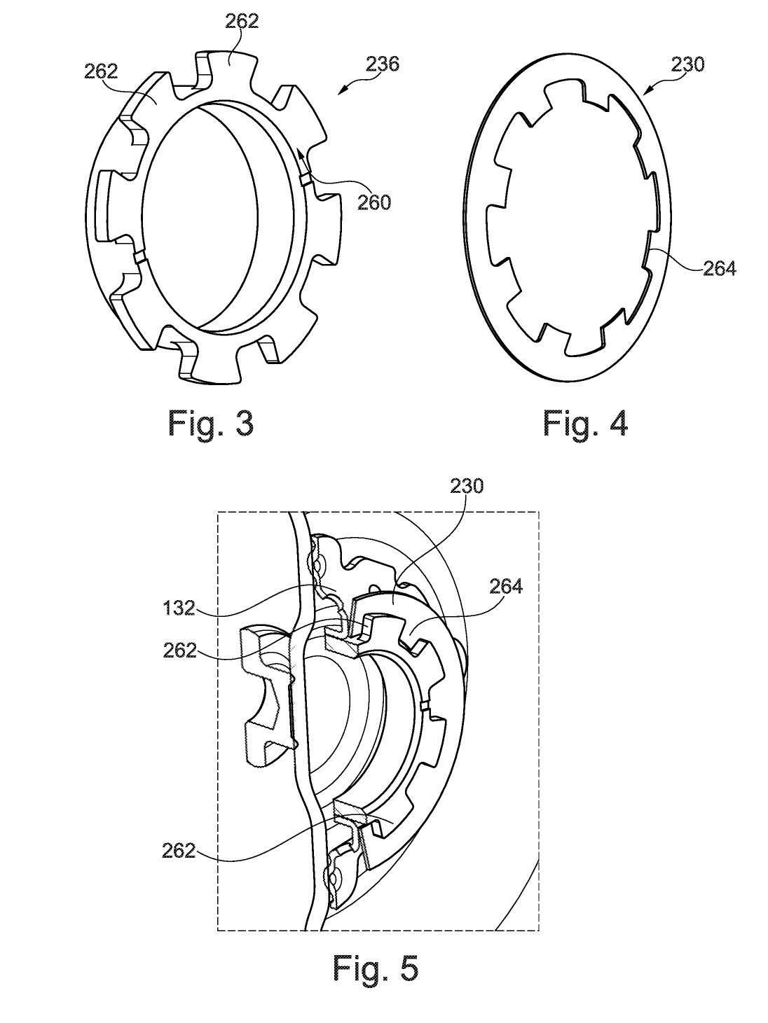

The following description is made with reference to FIGS. 1-5. FIG. 2 is a detail view of torque converter 200 showing an alternative embodiment. FIG. 3 is a perspective view of bushing 236 of FIG. 2. FIG. 4 is a perspective view of resilient element 230 of FIG. 2. FIG. 5 is a perspective view of torque converter 200 of FIG. 2 with the flange removed for clarity. Resilient element 230 is a diaphragm spring disposed between centering plate 134 and flange 222. Element 230 urges flange 130 away from cover assembly 202. The flange urges the cover plate away from the cover through contact at portion 158 (ref. FIG. 1). Bushing 236 includes flanged portion 260 with radial castellations 262. Diaphragm spring 230 includes radial castellations 264 drivingly engaged with radial castellations 262 for preventing relative rotation between the diaphragm spring and the bushing.

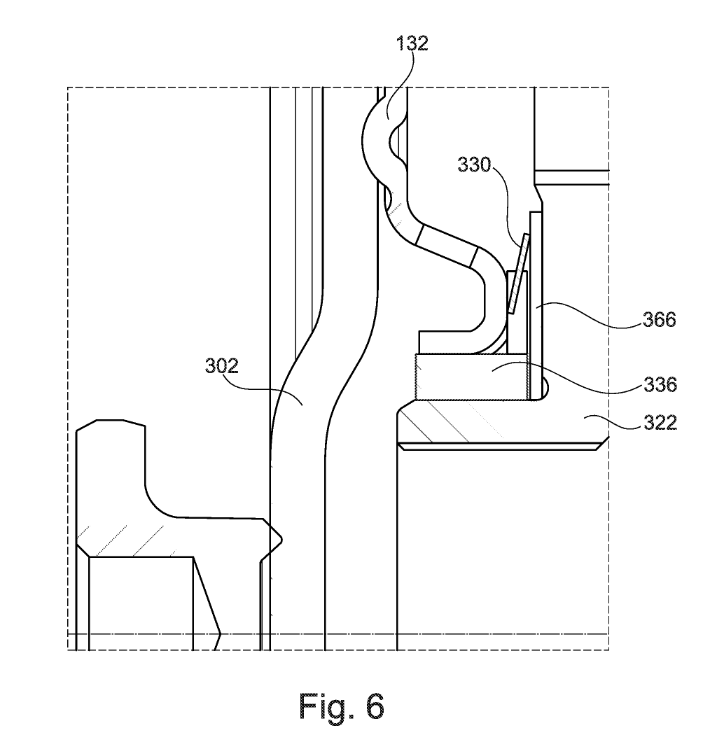

The following description is made with reference to FIGS. 1-6. FIG. 6 is a detail view of torque converter 300 showing an alternative embodiment. Torque converter 300 includes hardened washer 366 disposed axially between diaphragm spring 330 and flange 322.

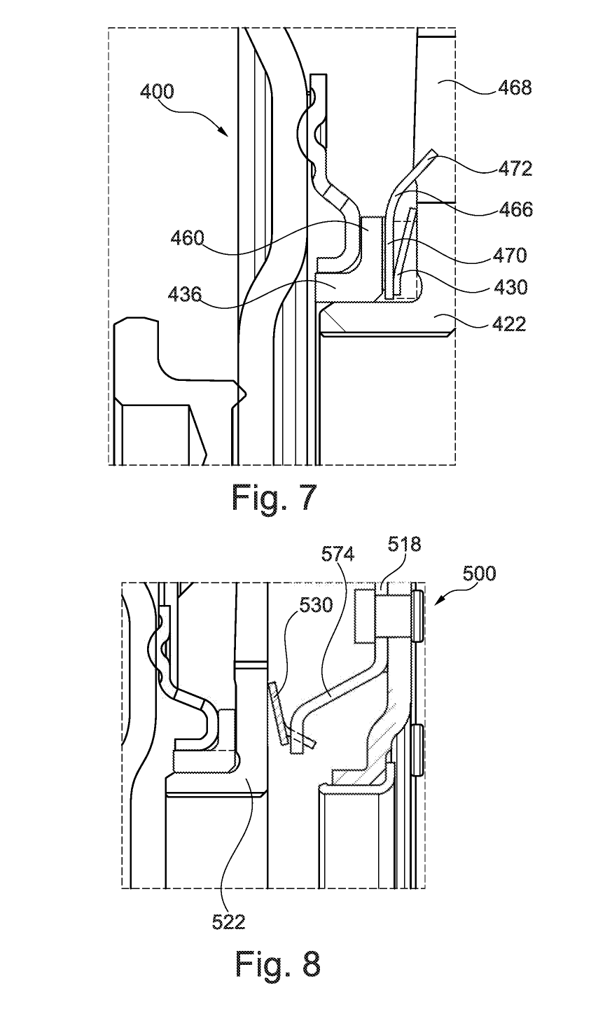

The following description is made with reference to FIGS. 1-7. FIG. 7 is a detail view of torque converter 400 showing an alternative embodiment. Torque converter 400 includes bushing 436, flange 422, and hardened washer 466 disposed axially between diaphragm spring 430 and bushing 436. The bushing includes annular portion 460 and the flange 422 includes cutouts 468. The hardened washer includes annular portion 470 matingly engaged with the bushing annular portion and tabs 472 installed in the flange cutouts for preventing relative rotation between the hardened washer and the flange.

The following description is made with reference to FIGS. 1-8. FIG. 8 is a detail view of torque converter 500 showing an alternative embodiment. Torque converter 500 includes diaphragm spring 530 disposed axially between cover plate 518 and flange 522. Cover plate 518 includes radially inwardly extending portion 574. Diaphragm spring 530 is disposed axially between the inwardly extending portion and the flange. The radially inwardly extending portion includes tabs 576 and the diaphragm spring includes tabs 578 engaged with tabs 576 for preventing relative rotation between the diaphragm spring and the cover plate.

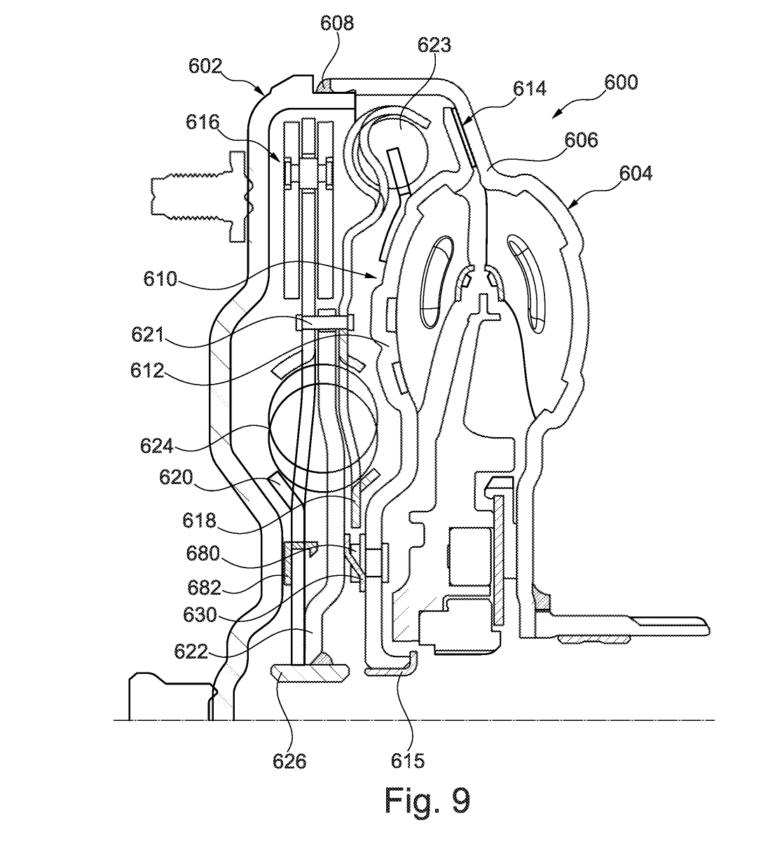

The following description is made with reference to FIGS. 1-9. FIG. 9 is a top half cross sectional view of torque converter 600 according to an example aspect. Torque converter 600 includes cover assembly 602, impeller assembly 604 including impeller shell 606 drivingly connected with the cover assembly at weld 608, and turbine assembly 610 including shell 612 with clutch portion 614 for selective driving engagement with the impeller shell. Clutch portion 614 operates in a manner similar to that shown and described in commonly-assigned United States Patent Publication No. 2013/0230385, hereby incorporated by reference as if set forth fully herein. Turbine assembly 610 further includes bushing 615 for sealing engagement with a transmission input shaft (not shown).

Converter 600 also includes damper assembly 616 disposed in a torque path between the turbine shell and a transmission input shaft (not shown). The damper assembly includes cover plates 618 and 620 fixed together at rivet 621, flange 622, and resilient element (i.e., coil spring) 124. Flange 622 is for driving engagement with a transmission input shaft (not shown) at hub portion 626, for example. Spring 624 is drivingly engaged with cover plates 618 and 620, and flange 622. That is, the springs transfer torque between the cover plates and flange. Cover plate 618 is drivingly engaged with the turbine shell at spring 623.

Torque converter 600 further includes resilient element 630 for urging turbine assembly 610 away from cover assembly 602. In other words, clutch portion 614 is preloaded against impeller shell 606. Resilient element 630 is disposed axially between the flange and the turbine shell, and fixed to the turbine shell at rivet 680. Torque converter 600 includes thrust washer 682 disposed axially between cover plate 620 and the cover assembly.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

1. A torque converter comprising:
a cover assembly;
an impeller assembly including an impeller shell drivingly connected with the cover assembly;
a turbine assembly including a turbine shell with a clutch portion for selective driving engagement with the impeller shell;
a damper assembly including:
at least one cover plate;
a flange for driving engagement with a transmission input shaft; and,
a first resilient element drivingly engaged with the at least one cover plate and the flange; and,
a second resilient element for urging the turbine assembly away from the cover assembly.

2. The torque converter of claim 1 wherein the at least one cover plate is fixed to the turbine shell and the second resilient element urges the at least one cover plate away from the cover assembly.

3. The torque converter of claim 2 wherein:
the cover assembly includes:
a centering plate; and,
a bushing press-fitted into the centering plate; and,
the flange includes a hub portion installed into the bushing and rotatable relative to the bushing.

4. The torque converter of claim 1 wherein the second resilient element is disposed axially between the flange and the turbine shell.

5. The torque converter of claim 4 wherein the second resilient element is fixed to the turbine shell.

6. The torque converter of claim 4 further comprising a thrust washer disposed axially between the at least one cover plate and the cover assembly.

7. A torque converter comprising:
an outer shell including a cover fixed to an impeller shell; and,
a turbine shell including a clutch portion preloaded against the impeller shell.

8. The torque converter of claim 7 wherein:
the impeller shell and the turbine shell comprise respective torus portions; and,
the clutch portion is disposed radially outside of the torus portions.

9. The torque converter of claim 7 further comprising a damper assembly disposed in a torque path between the turbine shell and a transmission input shaft.

10. The torque converter of claim 7 wherein the turbine shell clutch portion is preloaded against the impeller shell by a resilient element.

11. The torque converter of claim 10 wherein the resilient element reacts against the cover.

12. The torque converter of claim 7 further comprising a stator disposed axially between the impeller shell and the turbine shell.

13. The torque converter of claim 7 wherein the cover is arranged for driving engagement with a prime mover.

14. The torque converter of claim 3 wherein the second resilient element is a diaphragm spring disposed axially between the centering plate and the flange.

15. The torque converter of claim 14 wherein:
the bushing includes flanged portion with a first plurality of radial castellations; and,
the diaphragm spring includes a second plurality of radial castellations drivingly engaged with the first plurality of radial castellations for preventing relative rotation between the diaphragm spring and the bushing.

16. The torque converter of claim 14 further comprising a hardened washer disposed axially between the diaphragm spring and the flange.

17. The torque converter of claim 14 further comprising a hardened washer disposed axially between the diaphragm spring and the bushing, wherein:
the bushing includes a first annular portion;
the flange includes cutouts; and,
the hardened washer includes:
a second annular portion matingly engaged with the first annular portion of the bushing; and,
a plurality of tabs installed in the flange cutouts for preventing relative rotation between the hardened washer and the flange.

18. The torque converter of claim 3 wherein the second resilient element is a diaphragm spring disposed axially between the cover plate and the flange.

19. The torque converter of claim 18 wherein:
the at least one cover plate includes a radially inwardly extending portion; and,
the diaphragm spring is disposed axially between the radially inwardly extending portion and the flange.

20. The torque converter of claim 19 wherein:
the radially inwardly extending portion includes a plurality of first tabs; and,
the diaphragm spring includes a plurality of second tabs engaged with the plurality of first tabs for preventing relative rotation between the diaphragm spring and the cover plate.
